(19) United States
(12) Patent Application Publication
(10) Pub. No.: US 2026/0022470 A1
(43) Pub. Date: Jan. 22, 2026

(54) METHOD AND PLANT FOR PRODUCING HYDROGEN

(71) Applicant: Linde GmbH, Pullach (DE)

(72) Inventors: Andreas PESCHEL, Pullach (DE); Christian LIEBHART, Pullach (DE)

(21) Appl. No.: 18/994,944

(22) PCT Filed: Jul. 19, 2023
(86) PCT No.: PCT/EP2023/025337

§ 371 Date: Jan. 15, 2025

(30) Foreign Application Priority Data
Jul. 20, 2022 (EP) 22020347.5

(51) Int. Cl. C25B 1/04; C25B 9/23; C25B 9/65; C25B 15/021; C25B 15/08; H01M 8/10

(52) U.S. Cl. CPC C25B 1/04; C25B 9/23; C25B 9/65; C25B 15/021; C25B 15/08; H01M 8/10

(57) ABSTRACT

A method for producing hydrogen by means of water electrolysis, in which a direct electrolysis current is fed to one or more electrolysis units at least in a first operating mode, wherein the direct electrolysis current is supplied from a mains current using a current conversion arrangement, wherein the mains current is an alternating current, wherein the current conversion arrangement, comprises one or more first synchronous electric machines which are operable as motors and one or more second synchronous electric machines which are operable as generators, wherein the one or more first synchronous electric machines is/are operated using the mains current, wherein the one or more second synchronous electric machines is/are driven using the one or more first synchronous electric machines, and wherein the direct electrolysis current is supplied using the one or more second synchronous electric machines. The present invention also relates to a corresponding plant.

The invention relates to a method and a plant for producing hydrogen by means of water electrolysis, in which a direct electrolysis current is fed to one or more electrolysis units at least in a first operating mode, wherein the direct electrolysis current is supplied from a mains current using a current converter arrangement, wherein the mains current is an alternating current.

### BACKGROUND

Hydrogen production on an industrial scale is currently still based mainly on hydrocarbons and comprises, for example, steam reforming of natural gas or other gaseous feedstocks. Instead of a repeated explanation of what is already known, reference is made to relevant technical literature such as the articles “Gas Production, 2. Processes” and “Hydrogen, 2. Production” in Ullmann's Encyclopedia of Industrial Chemistry (e.g., the 2012 edition).

Water electrolysis is increasingly being used to produce hydrogen in order to use electricity generated from renewable sources and reduce carbon dioxide emissions. Oxygen can also be produced by water electrolysis.

In traditional water electrolysis, an aqueous alkaline solution, typically of potassium hydroxide, is used as the electrolyte (AEL, alkaline electrolysis). Electrolysis is carried out with a unipolar or bipolar electrode arrangement at atmospheric pressure or—on an industrial scale—significantly higher. More recent developments in water electrolysis include the use of proton-conducting ion exchange membranes (SPE, solid polymer electrolysis; PEM, proton exchange membranes), wherein the water to be electrolyzed is supplied on the anode side. Electrolysis technologies using an anion exchange membrane (AEM) are also used.

The methods mentioned are low-temperature methods in which the water to be electrolyzed is present in the liquid phase. In addition, so-called steam electrolysis is also used, which can likewise be carried out with alkaline electrolytes (i.e., as AEL) with adapted membranes, for example polysulfone membranes, and using solid oxide electrolysis cells (SOEC). The latter comprise in particular doped zirconium dioxide or rare earth oxides, which become conductive at high temperatures.

The term electrolysis will be used to refer to all of these methods. Low-temperature electrolyses (PEM, AEL, AEM) in particular are suitable for flexible operation, which supports the energy transition to renewable energies. All variants can be used in the present invention.

A plant of the generic type is known, for example, from CH 130772 A. It is characterized by the fact that the energy output is branched and a water electrolysis plant, which stores the energy not taken from the other branches in the form of electrolysis hydrogen, is connected in one branch. A direct current machine for generating the direct current used for the electrolysis system is provided. Further arrangements of this and other types are disclosed in DE 10 2011 114190 A1, DE 10 2019 128382 A1, DE 10 2017 211151 A1, WO 2019/246433 A1, KR 102 289 092 B1, WO 2016/161999 A1, KR 2013 0008192 A and WO 2011/055218 A1.

The object of the present invention is to improve corresponding methods and, in particular, to make them more flexible and energy-efficient.

### DISCLOSURE OF THE INVENTION

This object is achieved by a method and a plant for producing hydrogen having the features of the respective independent claims. Embodiments are the subject matter of the dependent claims and of the following description.

The present invention and embodiments thereof are based in particular on the realization that the use of an arrangement of synchronous electric machines as a current conversion arrangement or current supply unit is particularly advantageous in the areas of application explained above. In particular, within the framework of embodiments of the invention, such synchronous electric machines can be used as units connected or integrated into so-called synchronous motor-generator sets (SMGS).

Overall, the present invention proposes a method for producing hydrogen by means of water electrolysis, in which a direct electrolysis current is fed to one or more electrolysis units at least in a first operating mode, and wherein the direct electrolysis current is supplied from a mains current using a current conversion arrangement.

Within the framework of embodiments of the present invention, a permanent and uninterrupted implementation of such a first operating mode is possible, but other operating modes can also be provided, as explained below with reference to an embodiment of the present invention.

Embodiments of the present invention provide that the current conversion arrangement comprises one or more first synchronous electric machines which are operable as motors and one or more second synchronous electric machines which are operable as generators, wherein the one or more first synchronous electric machines is or are operated using the mains current, wherein the one or more second synchronous electric machines is or are (mechanically) driven using the one or more first synchronous electric machines, and wherein the direct electrolysis current is supplied using the one or more second synchronous electric machines. As already mentioned, first and second synchronous electric machines can be supplied in particular in the form of SMGS. Whenever the term “electric machine” is used in the following, in each case this refers to a synchronous electric machine, even if this is not explicitly mentioned in every case. This applies both in the case of mentions of the first electric machine(s) and in the case of mentions of the second electric machine(s).

In some embodiments of the invention, first and second synchronous machines or SMGS can be designed as a common structural unit, for example as so-called “skids” (i.e., a unit mounted in a common support or frame, which can in particular be mobile as such). In addition to the synchronous electric machines, corresponding control electronics and/or rectifiers can also be integrated into such a skid. This facilitates the installation and, if necessary, replacement or relocalization of plant components or entire electrolysis plants.

SMGS can use a simple rectifier topology, for example a diode. However, other rectifiers, in particular thyristor-based and/or IGBT-based rectifiers, can also be used within the framework of embodiments of the invention. When using SMGS, the excitation system takes over the control.

Electrolysis requires a variable voltage in order to compensate for degradation, on the one hand, and to follow load variations (e.g., wind profiles), on the other hand. For this reason, conventional concepts are based on controllable power electronics (e.g., a 12-pulse thyristor rectifier or a 6-pulse IGBT rectifier).

The synchronous generator (second synchronous electric machine) can be designed with a plurality of poles. For example, six stator windings can be used. In such a case, a 36-pulse rectifier system would be obtained. These poles can in turn be electrically separated from one another and can be rotated by a phase angle. In particular, each pole can be connected to one or more rectifiers connected in parallel. This means that 24-pulse or 36-pulse diode rectifiers can be realized. Higher-pulse systems offer a more constant direct voltage (DC ripple), with all per se known advantages (lower degradation, higher efficiency). Other numbers of windings, for example 3, 5, 6, 7, 8, 9, 10 or more, can also be used within the scope of the invention, wherein both the first and the second synchronous machine can have a corresponding number of windings and the first and second synchronous machines can have identical or different numbers of windings. In particular in cases in which the current conversion apparatus is operable “in both directions,” as explained in more detail below, it can be particularly useful to equip the first synchronous machine with three windings in order to be able to supply mains-compatible three-phase current directly. Alternatively, however, a different number of windings can also be used in such a case and the supplied current that is to be used for mains feed-in can be converted accordingly prior to the actual mains feed-in.

A comparable conventional system with 36 pulses (e.g., a thyristor) would require at least two or more power transformers.

With a higher-pulse system, each downstream (diode) rectifier carries only a portion of the current (e.g., 36 pulses->⅙ of the current). Therefore, according to embodiments of the invention, inexpensive standard components can be used.

Using the example of a 36-pulse system as just described, a further advantage can be illustrated, because in this case there would be six diode rectifier systems (one per stator winding). This increases the availability of the generator (the corresponding second synchronous electric machine), because if one of the rectifiers fails, the affected part can be isolated and the system can then continue to operate with a lower load.

Each rectifier based on power electronics causes negative impacts on the mains (e.g., harmonics, reactive power demand), which is why the technical connection requirements (TCRs) are becoming increasingly stringent. Compared to such conventional solutions, the mains feedback of the rectifier with the SMGS solution according to embodiments of the present invention is not passed on to the mains via the mechanical shaft. SMGS (i.e., combinations of first and second synchronous electric machines according to the invention) can thus meet all future mains requirements in this respect.

The rotating mass of the SMGS buffers short-term mains fluctuations of the feed-in mains in both directions. Since the output voltage of the SMGS is dependent only on the excitation system of the synchronous machine, the instantaneous reserve is available at all load points of the electrolyzer, even if it is only kept on standby. This helps to stabilize the frequency of the mains current.

SMGS can provide reactive power in a wide operating range and independently of the load point of the electrolyzer, which contributes to the voltage stabilization of the mains current. Short-circuit power can also be supplied. With the increasing decentralization of energy generation towards renewable energies, there will be a shortage of mains short-circuit power in the future. SMGS and especially plants with many SMGS can take over the task of providing short-circuit power from generators in large power plants (which are increasingly being taken off the mains as part of the expansion of renewable energy sources). As an alternative to generators for supplying short-circuit power, research is currently being carried out into coupling batteries with power electronics. However, this is far more expensive than the solution presented here, which is based on SMGS or comparable systems.

In particular, embodiments of the invention can provide for the current conversion apparatus, i.e. the combination of first and second synchronous electric machines or SMGS, to be operated as a control power plant (e.g., active power by load variation, reactive power through phase-shifting operation). This means that, in addition to the products from electrolysis, further commercial benefits can be derived from a corresponding plant.

The present invention and embodiments thereof can contribute in particular to a reduction in investment costs. This is achieved in particular by avoiding feedback effects caused by harmonic oscillations, so that the use of electrolyzers on a large scale is possible without negative feedback on the mains and operational capability. The installation of additional filters for reducing feedback for suppressing harmonic oscillations can be avoided. The same applies to the supply of measures for reactive power compensation, as required for conventional rectifiers, in order to compensate for the reactive power demand caused. Overall, this results in a lower specific material consumption (in particular of copper) compared to solutions not according to the invention or conventional solutions.

In particular, embodiments of the present invention can be used in environments classified as hazardous due to explosive atmospheres (ATEX) when using suitable designs of the proposed arrangements of electric machines.

In particular, in embodiments of the present invention, operation of such arrangements “in both directions” is possible, as explained in detail below with reference to corresponding embodiments. In other words, corresponding arrangements can supply the electrolysis system with current on the one hand, but also feed current back into the mains in the event of fuel cell operation. This is particularly relevant for combined installations of solid oxide electrolysis cells and solid oxide fuel cells (SOECs, SOFCs).

By using the present invention and embodiments thereof, scarce semiconductors in particular can be dispensed with. Energy advantages can be achieved in particular by using waste heat, as provided in embodiments of the present invention, for example, for heating a machine house, as further explained below.

The advantages of the measures proposed within the framework of the present invention and corresponding embodiments are discussed again below in other words and on the basis of prior art solutions not according to the invention.

A rectifier is required to be able to use alternating current (from the current mains, another alternating current source or from renewable energies) in an electrolysis system. Usable rectifiers are typically designed with thyristors or insulated-gate bipolar transistors (IGBTs) and cause mains disturbances due to harmonic waves caused by the phase-cut operation in the rectifier, as already mentioned above. In order to avoid these harmonics, in principle half-wave and full-wave control can be used.

In addition, corresponding rectifiers require reactive power from the mains. This is important particularly for weak grids or sources of current that are not connected to a higher-level grid (e.g., in offshore wind farms or solar parks or photovoltaic parks). In photovoltaic parks, the direct current generated by the photovoltaic modules must be converted initially into alternating current before it can be processed further in the mains. In wind farms, this is often reversed for frequency control. In both cases, however, considerable investment costs are required to convert the current from alternating current to direct current or vice versa.

In the event of an increasing number of electrolyzers being supplied for mains stabilization and large-scale use of renewable energies, limitations with regard to feedback by the mains operator must be expected, making it necessary to install feedback filters and means for reactive power compensation. Both lead to additional costs and reduced efficiency.

All of the disadvantages just explained can be avoided by using the present invention and corresponding embodiments.

Semiconductor elements (e.g., diodes, thyristors, IGBTs) can also be added within the scope of the present invention, in particular on the side of the electric machine which is operable as a generator. However, these semiconductor elements are then mechanically and electrically isolated from the mains side and therefore do not cause any mains disturbances.

In this connection, the present invention can generate both direct voltage and alternating voltage at any frequency on the side of the electric machine operable as a generator. For example, a higher frequency alternating voltage can be generated, which is then rectified by a diode bridge (or semiconductor bridge). Thus, a current converter arrangement that can be used within the framework of the present invention does not necessarily only have the first electric machine(s) operable as a motor(s) and the second electric machine(s) operable as a generator(s); rather, corresponding means can also be supplied for rectifying any alternating voltage supplied by means of the second electric machine(s). Therefore, when it is mentioned here that the direct electrolysis current is “supplied using the one or more second electric machines,” such supply can additionally comprise the use of one or more rectifiers. Such rectifiers can be designed in any conventional manner and can, for example, have diode bridges and semiconductor elements or power electronics.

In general, an “electric machine” is understood here to be a rotating synchronous electric machine, in particular a synchronous electric motor of any type and a synchronous generator of any type. An electric machine which is “operable as a motor” or “operated as a motor” works in the same way as an electric motor. It serves to convert electric power into mechanical power on a shaft. An electric machine which is “operable as a generator” or “operated as a generator” works in the same way as an electric generator and converts mechanical power into electric power. Certain types of electric machines, which are known to a person skilled in the art, can be operated both as motors (motor operation) and as generators (generator operation), wherein the specifically realized function is determined by the operating range of the machine. Such electric machines can be used in particular in embodiments of the present invention explained further below.

To avoid misunderstandings, it should be noted that the one or more first electric machines are operated as motors in the first operating mode, and that the one or more second electric machines are operated as generators in the first operating mode. This can be reversed in an (optional) second operating mode.

In embodiments of the present invention, one or more electrolysis units can be supplied, to which at least a portion of the direct electrolysis current supplied by means of one or more of the first electric machines is fed. In other words, in addition to a 1:1 arrangement of current conversion unit and electrolysis unit, a 1:2, 2:1, 1:3, 3:1 or any other arrangement (where the first number designates the number of current conversion unit(s) and the second number designates the number of electrolysis unit(s)) can also be used, provided this is appropriate in corresponding embodiments.

In embodiments of the present invention, the mains current can be alternating current or direct current and the first electric machine(s) can be adapted to a corresponding form of current. Embodiments of the present invention can thus be used advantageously with different forms of current.

In particular, the mains current can be supplied at a voltage level of more than 3, more than 5, more than 6 or more than 10 kV and, for example, up to 200 kV. The current converter unit supplied in embodiments of the present invention can advantageously be connected directly to a corresponding mains voltage. This is particularly possible if the high-voltage motors described below are used.

In embodiments of the present invention, the first electric machine(s) and the second electric machine(s) can also be mechanically coupled to one another, in particular by a fixed or switchable gearbox, in order to influence a rotational speed and a torque in a suitable manner if necessary. In this manner, a corresponding arrangement is operable particularly flexibly. It is also possible to connect a plurality of second electric machines to (in each case) a first electric machine or vice versa. A coupling without a gearbox, for example via a common shaft, is also possible, resulting in a particularly low-maintenance configuration.

In particular, in corresponding embodiments, the one or at least one of the plurality of first electric machines can be designed as an alternating current synchronous motor or as a direct current motor. These are the first electric machines that can be used particularly advantageously with the particular form of current. By means of a synchronous motor, reactive power can be supplied, in particular without the need for additional resources. Furthermore, no retroactive harmonic oscillations are generated.

Due to their inertia, the arrangements of electric machines used within the framework of the present invention and embodiments thereof are in particular also capable of bridging short-term voltage failures. The present invention has a mains-stabilizing effect; as already mentioned, kinetic rotational energy supports the mains during short-term voltage and/or frequency dips. In return, the present invention can draw energy from the mains during short-term frequency and/or voltage increases and store it in the form of kinetic energy. In such cases, machines are accelerated and can therefore absorb surplus energy from the mains. Both together thus serve as an instantaneous reserve. The measures proposed within the framework of the present invention can be used for mains-supportive power control. For compensating corresponding electric power, suitable EZA or park controllers can be supplied according to the standards applicable in each case.

In one embodiment of the present invention, at least one of the plurality of first electric machines can be formed as a cable-wound HV motor, for example as described in ABB Review 1/2001, pages 22 to 25, and the literature cited therein. In this manner, for example, high voltages of up to 152 kV can be fed directly into a corresponding electric machine without a transformer.

In embodiments of the present invention, the one or more first electric machines is or are furthermore operable as a generator and the one or more second electric machines is or are furthermore operable as a motor, i.e. in each case in the “reverse direction” as explained above.

In a second operating mode, which is carried out in particular during a period in which the first operating mode is not carried out, the one or at least one of the plurality of electrolysis units is or are operated as one or more fuel cells while supplying direct fuel cell current. It supplies or they supply the corresponding current. However, it is also possible that one or more fuel cells are additionally provided and deliver the corresponding direct fuel cell current. The one or more second electric machines, which in this case is or are operated as motors, is or are operated using the direct fuel cell current, and the one or more first electric machines, which in this case is or are operated as generators, is or are driven using the one or more second electric machines. At least a portion of the current supplied by the one or more first electric machines can be supplied as mains current and fed into a corresponding grid. This is particularly advantageous for stand-alone solutions and for support in the event of temporarily low mains power.

In one such embodiment of the invention, it can in particular be provided that the one or at least one of the plurality of electrolysis units is or are operated as at least one solid oxide electrolysis cell in the first operating mode and as at least one solid oxide fuel cell in the second operating mode. If one or more additional fuel cells are supplied, these can be operated as solid oxide fuel cell(s). An arrangement with (separate) fuel and electrolysis cells is also possible, so that a corresponding arrangement can be advantageously adapted to the particular purpose.

In embodiments of the present invention, the one or at least one of the plurality of electrolysis units can be configured for alkaline electrolysis with a unipolar or bipolar electrode arrangement and/or for chloralkali electrolysis, and/or can be operated using a proton-conducting ion exchange membrane or using an anion exchange membrane. All embodiments of corresponding electrolysis units, as explained above, can be used in embodiments of the invention.

In further embodiments of the present invention, the mains current can be current that is fed into a grid using one or more photovoltaic plants, using one or more wind power plants and/or using one or more energy storage units. The present invention and embodiments thereof are particularly advantageous in such embodiments, for the reasons already mentioned several times.

Embodiments of the present invention comprise the utilization of waste heat from the current conversion arrangement, at least in part, in the one or at least one of the plurality of electrolyte units. Here, the heating of a machine house and the like is also possible. In such buildings, increased air exchange can be advantageous, in particular for the removal of escaping hydrogen, so that an increased heating capacity is required. In particular, heated electrolysis units such as solid oxide cells are operable advantageously in corresponding embodiments.

In embodiments of the present invention, it can be provided that alternating current is generated in the first operating mode by means of the one or more second electric machines which are operable as generators and are operated as generators in the first operating mode, which alternating current is converted into the alternating electrolysis current by means of one or more rectifier arrangements (e.g., diode or thyristor rectifiers). This has already been explained previously. A corresponding rectifier can be controlled in particular by means of known control or regulation means.

A plant for producing hydrogen by means of water electrolysis, which has one or more electrolysis units and a current conversion arrangement and is configured to feed direct electrolysis current to the one or more electrolysis units at least in a first operating mode and to supply the direct electrolysis current from a mains current using the current conversion arrangement, is also the subject matter of the present invention.

The current conversion arrangement comprises one or more first electric machines which are operable as motors and one or more second electric machines which are operable as generators, wherein the plant is configured to operate the one or more first electric machines using the mains current, to drive the one or more second electric machines using the one or more first electric machines, and to supply the direct electrolysis current using the one or more second electric machines.

For further features and advantages of a corresponding plant, express reference is made to the description of the method according to the invention and corresponding embodiments, since they relate to the plant in its various embodiments in the same manner.

A corresponding plant, by means of which a method described above can be carried out in various embodiments, and which in particular has corresponding means and is configured to carry out such a method, can also be the subject matter of embodiments of the invention.

The invention is further explained below with reference to the drawings, which illustrate one embodiment of the present invention.

### BRIEF DESCRIPTION OF THE DRAWINGS

FIG. 1 illustrates a plant according to an embodiment of the invention.

FIG. 2 illustrates a plant according to an embodiment of the invention.

FIG. 3 illustrates a plant according to an embodiment of the invention.

FIG. 4 illustrates a plant according to FIG. 1 in a second operating mode.

FIG. 5 shows three examples of current converter arrangements that can be used within the scope of the invention.

In the figures, corresponding or functionally and/or structurally identical, substantially identical or corresponding elements are indicated with identical reference signs, wherein explanations relating to plant components concern method steps in the same manner and vice versa.

### DETAILED DESCRIPTION OF THE DRAWINGS

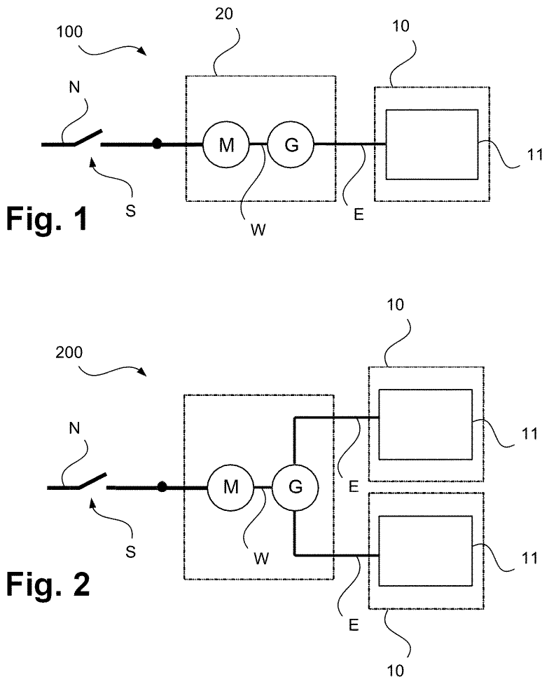

In FIG. 1, a plant according to one embodiment of the invention is illustrated in the form of a highly simplified plant diagram and is denoted as a whole as 100.

The plant 100 illustrated in FIG. 1 is configured for producing hydrogen by means of water electrolysis and has one or more electrolysis units 10 of the type described above for this purpose. One or more electrolyzers or electrolysis points are numbered 11. Furthermore, a current converter arrangement 20 is supplied in the plant 100.

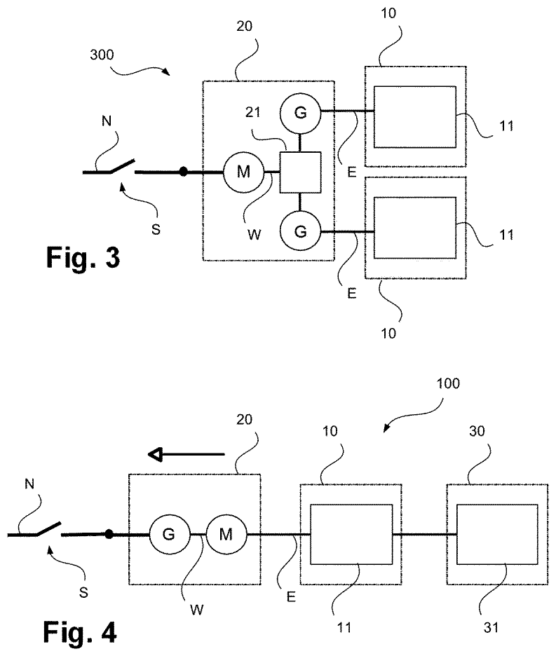

In at least a first operating mode (an optional second operating mode is explained with reference to FIG. 3), the plant 100 is configured to feed direct electrolysis current to the one or more electrolysis units 10 via one or more lines denoted as E, and to supply the direct electrolysis current E using the current conversion arrangement 20 from a mains current flowing in a current mains N.

Whereas in conventional plants a corresponding current conversion arrangement is formed by means of semiconductors, the current conversion arrangement 20 supplied in embodiments of the invention has one or more first electric machines M which are operable as motors and one or more second electric machines G which are operable as generators. In each case, these can be designed as motor(s) or generator(s) or, in embodiments of the invention, as electric machines M, G which are operable in “both directions”, in each case of any type, as explained several times. However, the second electric machine(s) G in particular are generally designed as synchronous machines. This can also apply to the first electric machine(s) M. The second electric machine(s) G in each case has (have) a rectifier, for example a diode rectifier or a rectifier of any other design, which is not shown separately in all figures. The rectifier converts the alternating current generated by the second electric machine(s) G into the direct electrolysis current E, as explained in more detail below.

The plant 100 is configured to operate the one or more first electric machines M using the mains current from the mains N, to drive the one or more second electric machines G using the one or more first electric machines M, in particular via a shaft W, and to supply the direct electrolysis current using the one or more second electric machines G. A switch S can be provided for connection to or disconnection from the mains N.

FIG. 2 illustrates a plant according to a further embodiment of the invention, which is denoted as 200.

The plant 200 illustrated in FIG. 2 differs from the plant 100 illustrated in FIG. 1 in particular by the supply of two electrolysis units 10, which are connected to a current converter arrangement 20 or a second electric machine G. Alternative embodiments have already been mentioned several times.

FIG. 3 illustrates a plant according to a further embodiment of the invention, which is denoted as 300.

The plant 300 illustrated in FIG. 3 differs from the plant 100 illustrated in FIG. 1, in particular with regard to the connection of two second electric machines G which are operable as generators to a first electric machine M which is operable as a motor. In particular, a suitable device 21 can be supplied here that introduces the torque of the shaft W into the two second electric machines G, for example a gearbox.

This is only an example, so that any other number of second electric machines G can also be connected to a first electric machine M or to a plurality of first electric machines M and vice versa.

A connection of a plurality of second electric machines G to a common first electric machine M can also be realized without a gearbox, for example via both shaft ends of the first electric machine M or by means of an extended shaft, so that the first M and all second G electric machines connected to it are arranged on a common shaft or on concentric shafts that are mechanically connected to one another.

FIG. 4 illustrates a plant according to FIG. 1, which is further denoted here as 100, in a second operating mode.

In the embodiment illustrated in FIG. 4, the one or more first electric machines M can (also) be operated as a generator and the one or more second electric machines G can (also) be operated as a motor.

In the second method mode illustrated in FIG. 4, the one or at least one of the plurality of electrolysis units 10 is or are operated as one or more fuel cells, as illustrated by means of an arrow, while supplying direct fuel cell current. It is also possible to supply additional fuel cell arrangements, as additionally illustrated with a corresponding arrangement 30 with fuel cell(s) 31.

The one or more second electric machines G is or are operated using the direct fuel cell current and the one or more first electric machines M is or are driven using the one or more second electric machines G. Current supplied using the one or more first electric machines M is fed as mains current and fed into the mains N.

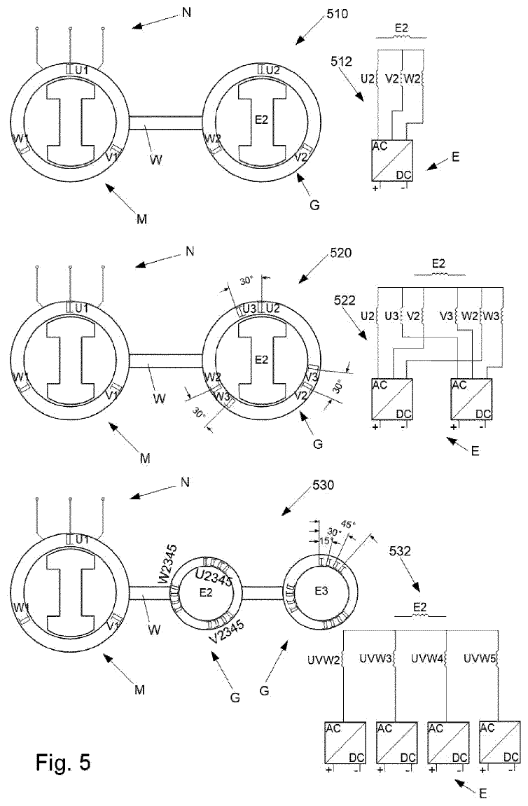

FIG. 5 shows three examples of current converter arrangements 20 that can be used within the scope of the invention, which are in each case denoted as 510, 520 and 530. Each of the current converter arrangements 510, 520, 530 shown has a first electric machine M, which is operated with mains current N. In the examples shown here, the mains current N is three-phase alternating current in each case. In all three examples shown here, the first electric machine M has three phase windings U1, V1, W1 in each case. In motorized operation of the first electric machine M, the torque generated by the first electric machine M is transmitted via the shaft W to one or—in the case of the current converter arrangement 530—two second electric machines G, which are operated as generators. The second electric machine(s) is or are controlled in terms of output by means of the excitation of the particular excitation winding E2 or E3.

In example 510, the second electric machine G has three phase windings U2, V2, W2, which are offset by 120° to one another in each case, and accordingly initially generates a three-phase alternating current (three-phase current). The three-phase alternating current is converted into a six-pulse direct current by means of a rectifier circuit 512, which is used as the direct electrolysis current E in embodiments of the invention.

In example 520, instead of the three individual phases U2, V2, W2 used in example 510, the second electric machine G has three phase pairs U2/U3, V2/V3 and W2/W3, wherein in the example shown here the individual phases belonging to the same phase pair are shifted by 30° relative to one another in each case. This results in a twelve-pulse direct electrolysis current E at the output of the associated rectifier circuit 522.

In example 530, each of the two second electric machines G has three quadruple phases U2/3/4/5, V2/3/4/5, W2/3/4/5 in each case, wherein the individual phases attached to the same quadruple phase are shifted by 15° relative to one another in each case. In each case, this results in a 24-pulse direct electrolysis current for the two second electric machines G after conversion by the corresponding rectifier circuit 532 (which is shown here in somewhat less detail for reasons of clarity, in that the lines of the different main phases are shown combined, and in that only one of two identically constructed rectifier circuits 532 is shown). Thus, the direct electrolysis current E can be a uniform 48-pulse direct current if the two second electric machines G are suitably arranged relative to one another.

As already explained at the beginning, a multi-pulse direct current has the advantage that the electric components are in each case subjected to less stress, thus increasing the overall service life of the components.

It should be emphasized here that the examples of current conversion arrangements shown in FIG. 5 serve only for illustrative purposes and that the invention can also be implemented with arrangements deviating therefrom, as long as the features defined in the claims are fulfilled in each case.

1. A method for producing hydrogen by means of water electrolysis, in which a direct electrolysis current is fed to one or more electrolysis units at least in a first operating mode, wherein the direct electrolysis current is supplied from a mains current using a current conversion arrangement, wherein the mains current is an alternating current, wherein the current conversion arrangement comprises one or more first synchronous electric machines which are operable as motors and one or more second synchronous electric machines which are operable as generators, wherein the one or more first synchronous electric machines is or are operated using the mains current, wherein the one or more second synchronous electric machines is or are driven using the one or more first synchronous electric machines, and wherein the direct electrolysis current is supplied using the one or more second synchronous electric machines.

2. The method according to claim 1, in which one or more electrolysis units are provided, to which at least a portion of the direct electrolysis current supplied by means of the one or at least one of the plurality of second synchronous electric machines is fed.

3. The method according to claim 1, in which the mains current is provided at a voltage level of more than 3, more than 6 or more than 10 kV.

4. The method according to claim 1, in which the one or at least one of the plurality of first synchronous electric machines is designed as an alternating current synchronous motor.

5. The method according to claim 4, in which at least one of the plurality of first electric machines is designed as a cable-wound high-voltage motor.

6. The method according to claim 1, in which the one or more first synchronous electric machines is or are further operable as generators and the one or more second synchronous electric machines is or are further operable as motors, wherein, in a second method mode, the one or at least one of the plurality of electrolysis units is or are operated as one or more fuel cells while supplying direct fuel cell current and/or one or more fuel cells supplied in addition to the one or more electrolysis units are operated while supplying direct fuel cell current, wherein the one or more second synchronous electric machines is or are operated using the direct fuel cell current, wherein the one or more first synchronous electric machines is or are driven using the one or more second synchronous electric machines, and current supplied using the one or more first synchronous electric machines is supplied as mains current.

7. The method according to claim 6, in which the one or at least one of the plurality of electrolysis units is or are operated in the first operating mode as at least one solid oxide electrolysis cell and in the second operating mode as at least one solid oxide fuel cell and/or with which the one or more fuel cells supplied in addition to the one or more electrolysis units is or are operated as one or more solid oxide fuel cells.

8. The method according to claim 1, in which the one or at least one of the plurality of electrolysis units is configured for alkaline electrolysis with a unipolar or bipolar electrode arrangement and/or for chloralkali electrolysis and/or is operated using a proton-conducting ion exchange membrane or using an anion exchange membrane.

9. The method according to claim 1, in which the mains current is current that is fed into a grid using one or more photovoltaic plants, using one or more wind power plants and/or using one or more energy storage units.

10. The method according to claim 1, in which waste heat from the current conversion arrangement is utilized, at least in part, in the one or at least one of the plurality of electrolysis units.

11. The method according to claim 1, in which in the first operating mode alternating current is generated by means of the one or more second synchronous electric machines which are operable as generators, which alternating current is converted into the direct electrolysis current by means of one or more rectifier arrangements.

12. The method according to claim 1, in which at least one of the first and/or second synchronous electric machines has a plurality of phase windings, in particular wherein a number of phase windings of a particular synchronous electric machine is selected from the natural numbers of the interval [2; 20], wherein first and second synchronous electric machines have the same or different numbers of phase windings relative to one another.

13. A plant for producing hydrogen by means of water electrolysis, which has one or more electrolysis units and a current conversion arrangement and is configured to feed direct electrolysis current to the one or more electrolysis units at least in a first operating mode and to supply the direct electrolysis current from a mains current using the current conversion arrangement, wherein the current conversion arrangement comprises one or more first synchronous electric machines which are operable as motors and one or more second synchronous electric machines which are operable as generators, and wherein the plant is configured to operate the one or more first synchronous electric machines using the mains current, to drive the one or more second synchronous electric machines using the one or more first synchronous electric machines, and to supply the direct electrolysis current using the one or more second synchronous electric machines.

14. The plant according to claim 13, which is configured to carry out a method for producing hydrogen by means of water electrolysis, in which a direct electrolysis current is fed to one or more electrolysis units at least in a first operating mode, wherein the direct electrolysis current is supplied from a mains current using a current conversion arrangement, wherein the mains current is an alternating current, wherein the current conversion arrangement comprises one or more first synchronous electric machines which are operable as motors and one or more second synchronous electric machines which are operable as generators, wherein the one or more first synchronous electric machines is or are operated using the mains current, wherein the one or more second synchronous electric machines is or are driven using the one or more first synchronous electric machines, and wherein the direct electrolysis current is supplied using the one or more second synchronous electric machines.
